(19) United States
(12) Patent Application Publication
(10) Pub. No.: US 2015/0347311 A1
(43) Pub. Date: Dec. 3, 2015

(54) STORAGE HIERARCHICAL MANAGEMENT SYSTEM

(71) Applicant: HITACHI, LTD., Chiyoda-ku, Tokyo (JP)

(72) Inventors: Toru TANAKA, Tokyo (JP); Shinichi HAYASHI, Tokyo (JP); Akihisa NAGAMI, Tokyo (JP)

(21) Appl. No.: 14/759,590

(22) PCT Filed: Jan. 9, 2013
(86) PCT No.: PCT/JP2013/050154

§ 371 Date: Jul. 7, 2015

(51) Int. Cl. G06F 12/08; G06F 3/06

(52) U.S. Cl. CPC G06F 12/0897; G06F 3/061; G06F 3/0644; G06F 3/0683; G06F 2212/313

(57) ABSTRACT

Since an application or an administrator of the application copies data having a high frequency of reference from a storage to an upper tier within a server or the storage, when I/O concentrates to data other than the data copied to the server by the application, the performance of the storage is deteriorated. Therefore, according to the present invention, a management computer performs tier management of data stored in any of multiple types of storage devices disposed in the storage system according to an access status thereof, and in conjunction with the application, also sets data stored in the multiple types of storage device other than the data accessed by the processing of the application as a target of tier management.

### TECHNICAL FIELD

The present invention relates to a storage tier management performed in a system in conjunction with an application, and more specifically, relates to an art of enhancing the performance of computers and storage systems.

### BACKGROUND ART

Recently, accompanying the improvement of performance of computers, it has become possible to have multiple applications including databases and virtual machines operate in a physical computer.

An art to store copied data of the data stored in a storage system to a server is provided to applications with the aim to increase the speed of startup or operation of the applications.

There is another art provided to enable disks having different performances, such as SSDs and HDDs constituting the storage, to exist in a mixture within the storage area in a tiered manner. According to these arts, it becomes possible to arrange a collection of block data called pages within the storage to tiers according to a frequency of use of the application, and control the same. There is also an art of designating the tiers to be used according to application, and at a timing of tier relocation of a certain page, also migrating a data of the same file as the page being the target of relocation to the tier determined in advance (Patent Literature 1).

### CITATION LIST

### Patent Literature

[PTL 1] International Patent Publication No. 2011/145138
(United States Patent Application Publication No. 2011/0289287)

### SUMMARY OF INVENTION

### Technical Problem

However, according to the art of increasing the speed of the application and based on Patent Literature 1, the application itself or an administrator of the application copies the data assumed to have high frequency of reference from the storage to the server or the upper tier within the storage. However, in actual use of the application, if I/O concentrates to data other than the data copied by the application to the server or the upper tier, there is a drawback that the performance of the system is deteriorated.

The present invention aims at solving the problems of the prior art mentioned above, and provides a way to optimize the system performance in conjunction with the operation of the application.

### Solution to Problem

The management computer performs tier management of data stored in any of the multiple types of storage devices within the storage system among the multiple types of storage devices according to an access status thereof, and in conjunction with an application, further sets data stored in the multiple types of storage devices other than the data accessed via processing of the application as a target of tier management.

### Advantageous Effects of Invention

According to the present invention, it becomes possible to perform tier management of not only the data being the target of operation of the application but also the data corresponding thereto. Thus, the amount of use of disks can be cut down while maintaining an appropriate performance.

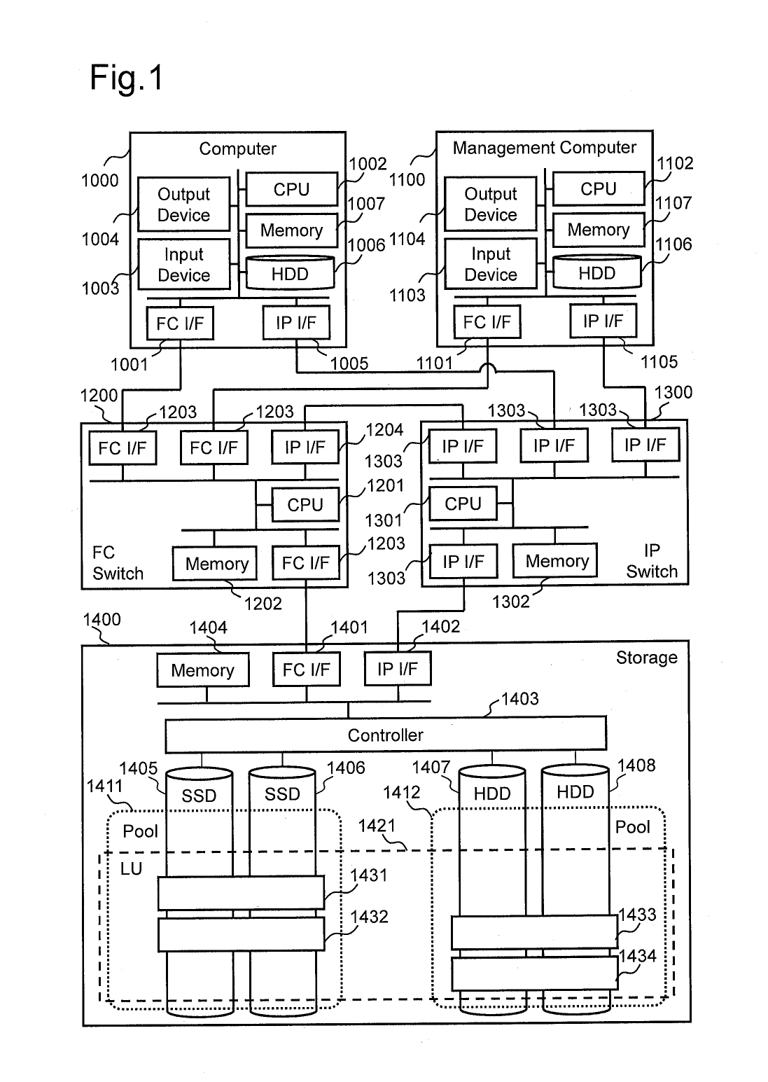

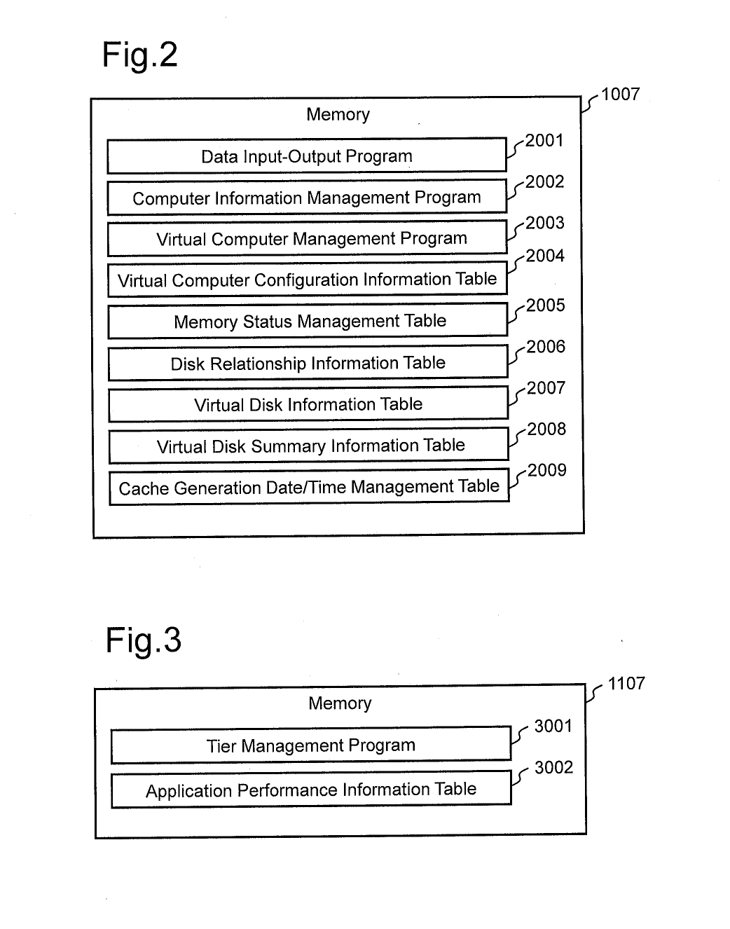

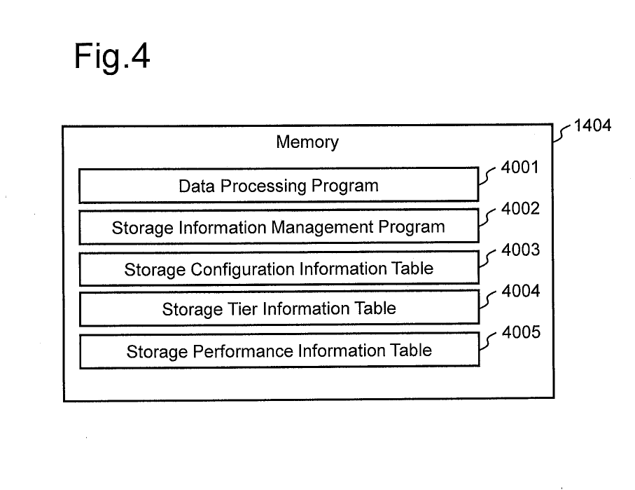

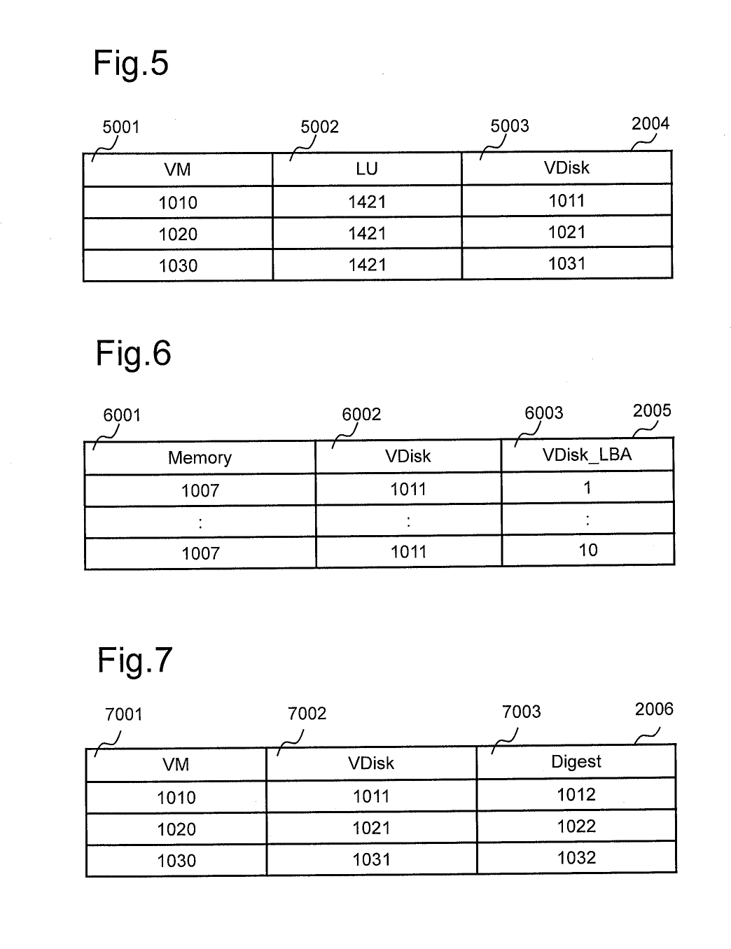

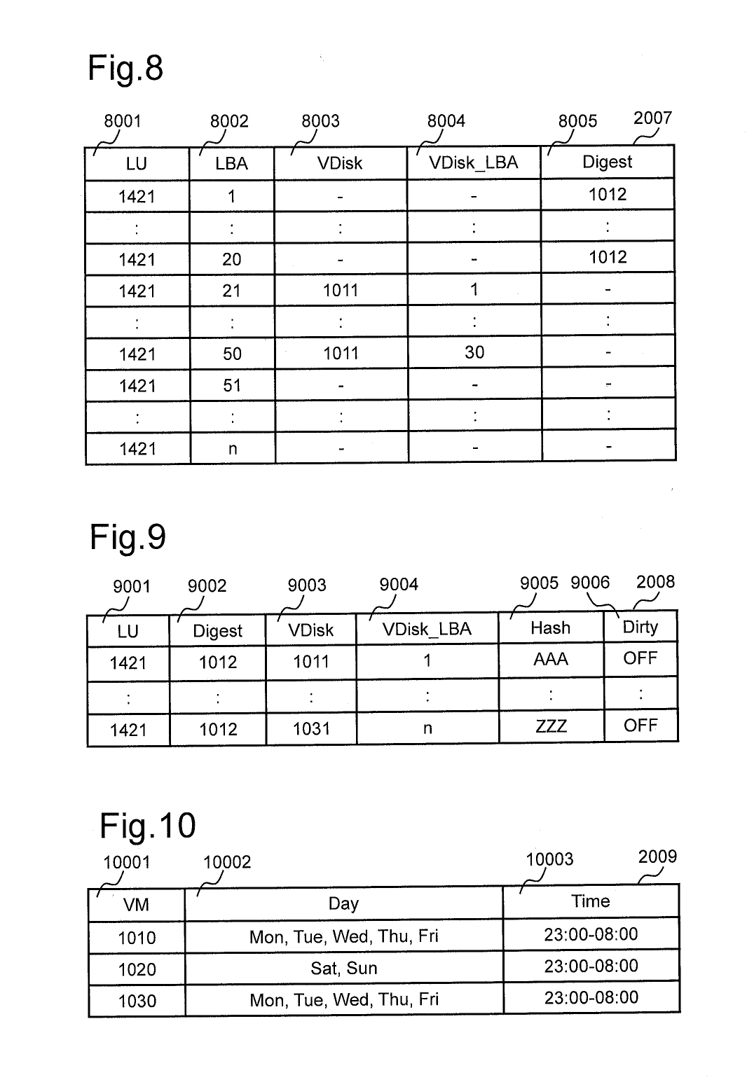

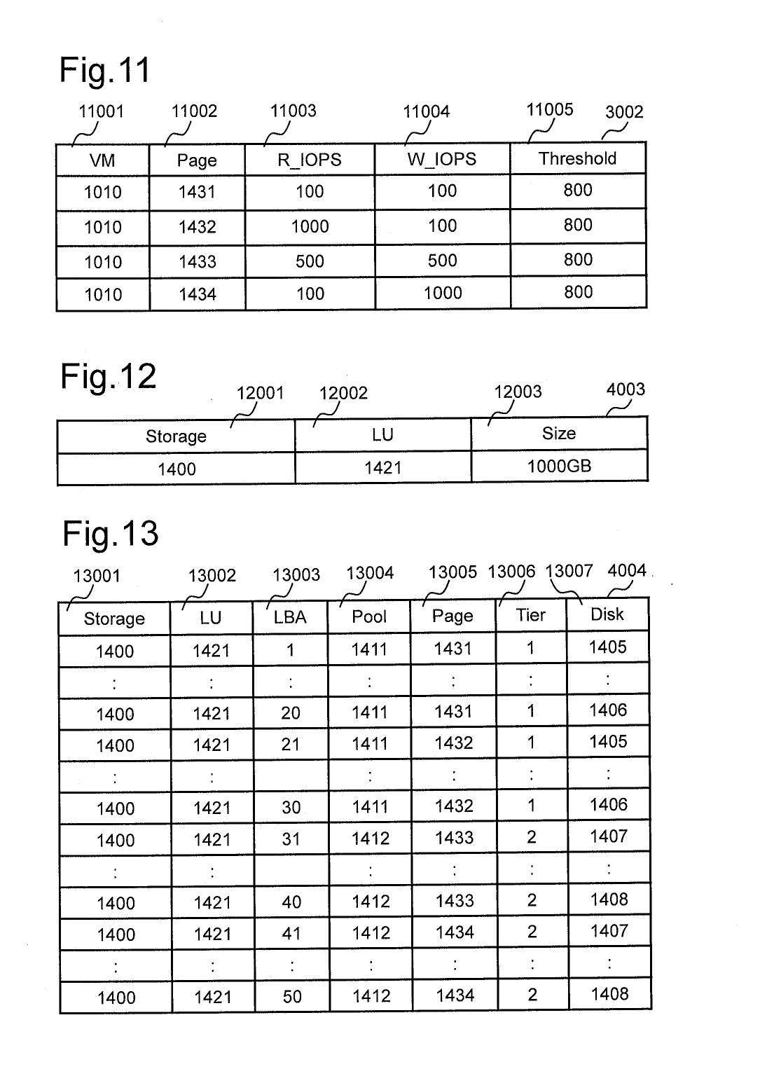

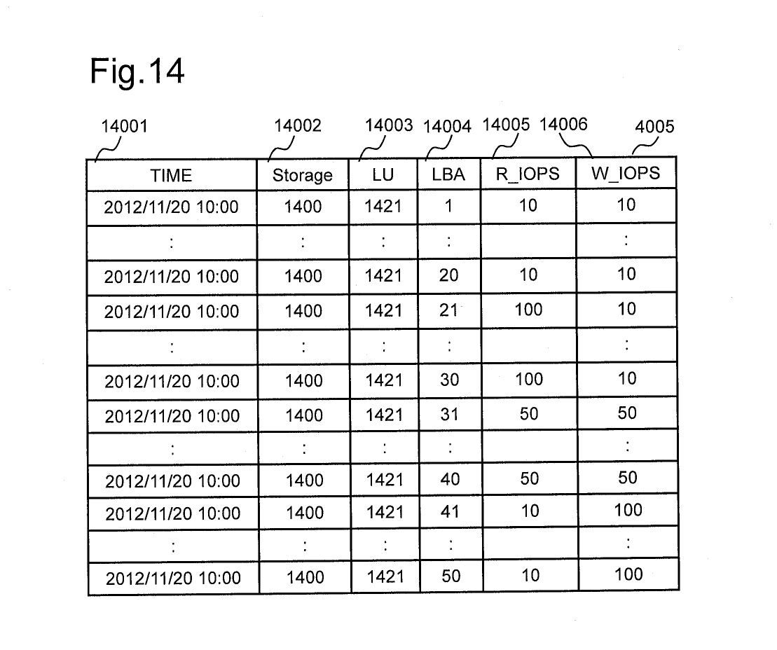

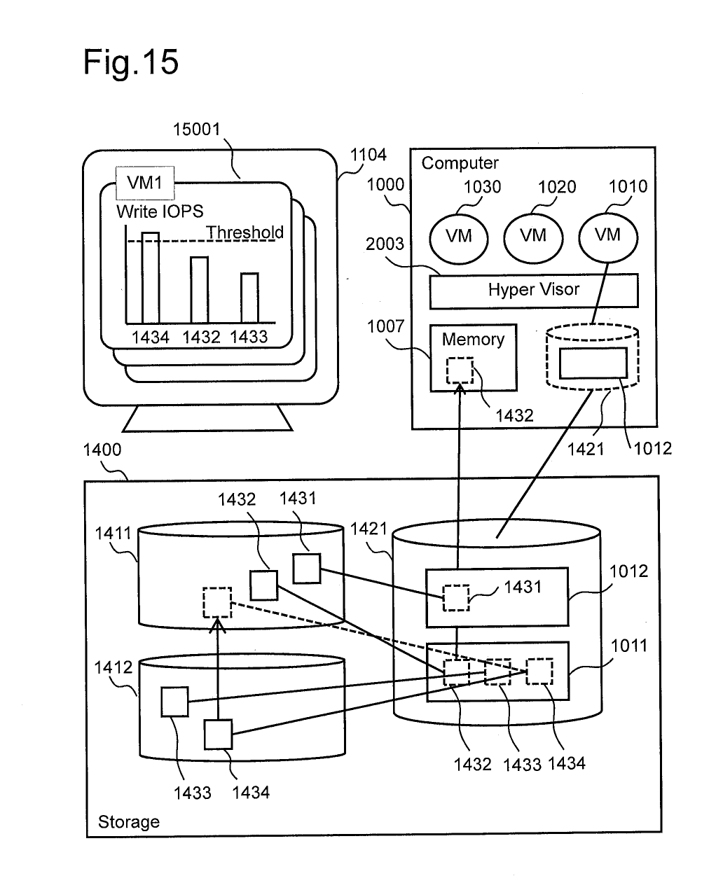

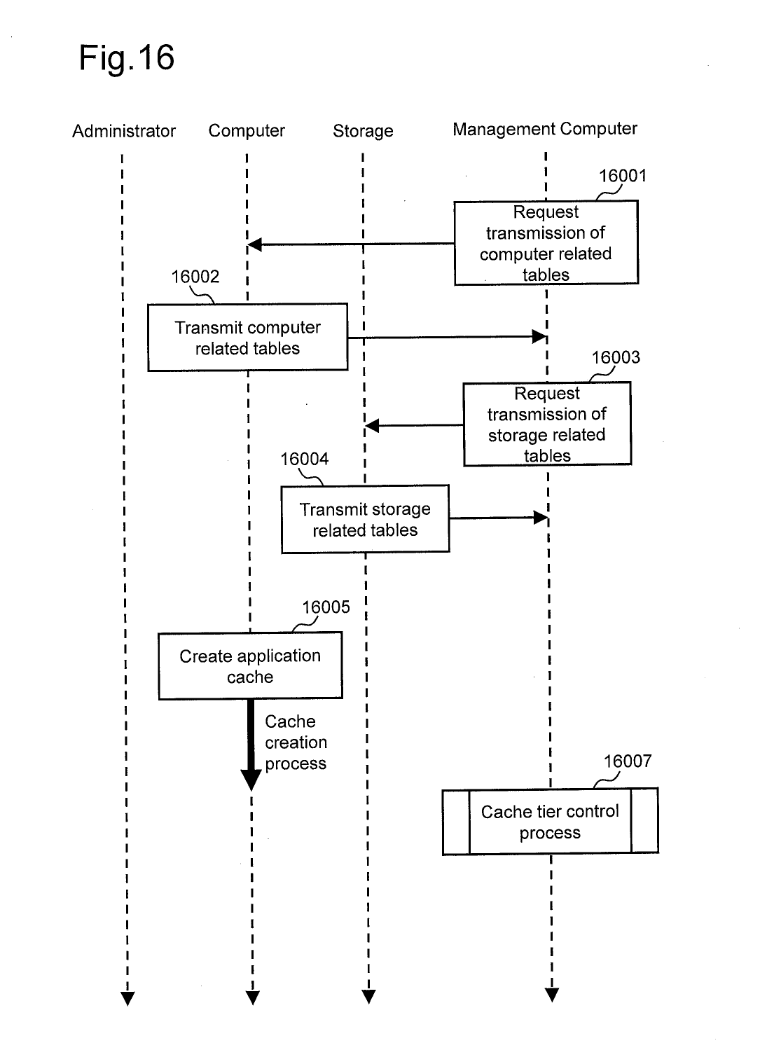

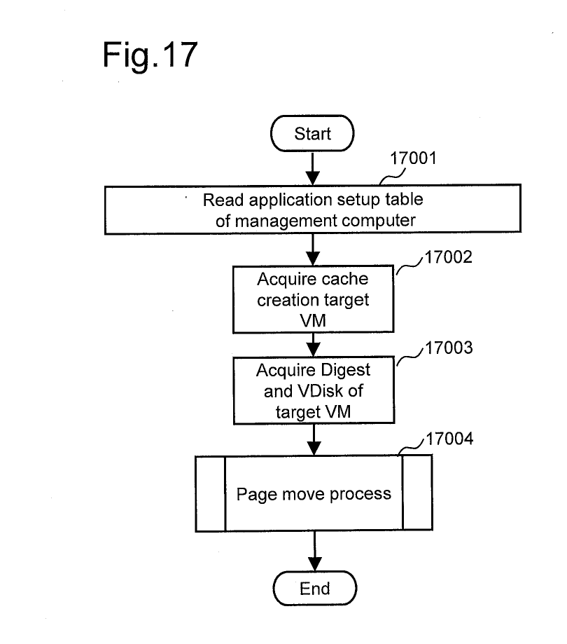

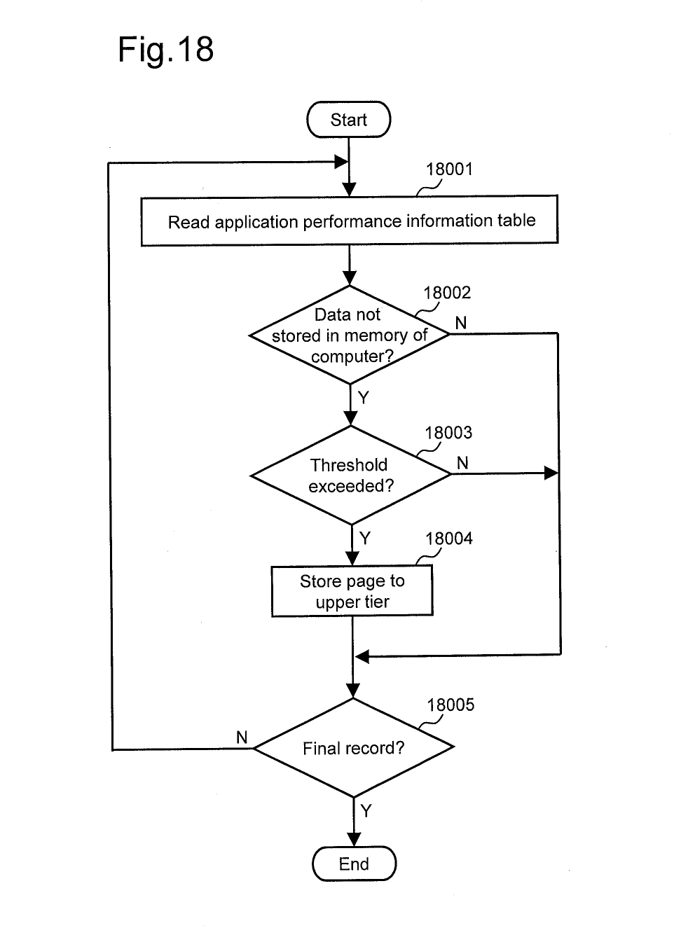

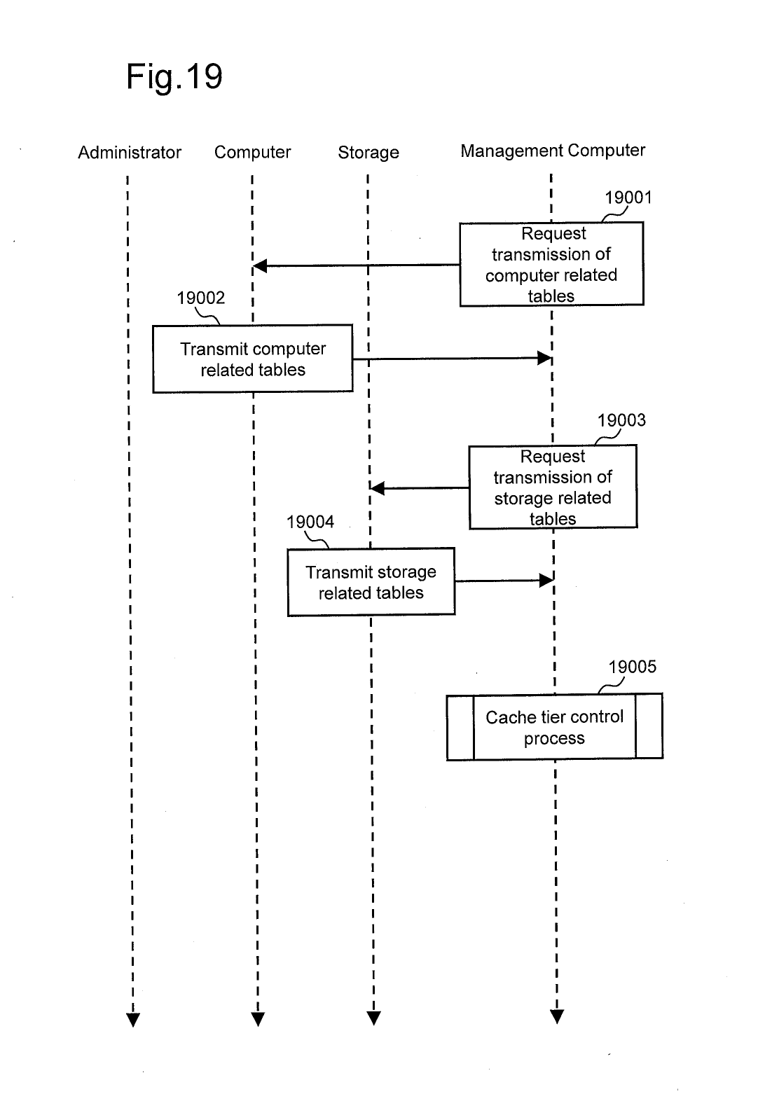

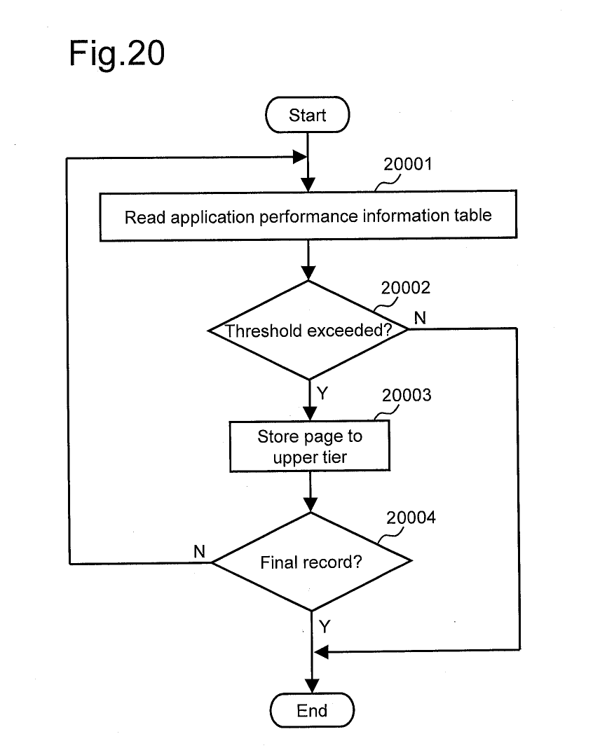

### BRIEF DESCRIPTION OF DRAWINGS

[FIG. 1] FIG. 1 is a view illustrating a system configuration according to an embodiment of the present invention.

[FIG. 2] FIG. 2 is a view illustrating a memory configuration of a computer according to the embodiment of the present invention.

[FIG. 3] FIG. 3 is a view illustrating a memory configuration of a management computer according to the embodiment of the present invention.

[FIG. 4] FIG. 4 is a view illustrating a memory configuration of a storage system according to the embodiment of the present invention.

[FIG. 5] FIG. 5 is a view illustrating a virtual computer configuration information table according to the embodiment of the present invention.

[FIG. 6] FIG. 6 is a view illustrating a memory status management table according to the embodiment of the present invention.

[FIG. 7] FIG. 7 is a view illustrating a disk relationship information table according to the embodiment of the present invention.

[FIG. 8] FIG. 8 is a view illustrating a virtual disk information table according to the embodiment of the present invention.

[FIG. 9] FIG. 9 is a view illustrating a virtual disk summary information table according to the embodiment of the present invention.

[FIG. 10] FIG. 10 is a view illustrating a cache generation date and time management table according to the embodiment of the present invention.

[FIG. 11] FIG. 11 is a view illustrating an application performance information table according to the embodiment of the present invention.

[FIG. 12] FIG. 12 is a view illustrating a storage configuration information table according to the embodiment of the present invention.

[FIG. 13] FIG. 13 is a view illustrating a storage tier information table according to the embodiment of the present invention.

[FIG. 14] FIG. 14 is a view illustrating a storage performance information table according to the embodiment of the present invention.

[FIG. 15] FIG. 15 is a view illustrating a logical configuration of a computer and a storage system according to the embodiment of the present invention.

[FIG. 16] FIG. 16 is a view illustrating a performance management process according to embodiment 1 of the present invention.

[FIG. 17] FIG. 17 is a view illustrating a cache tier control process according to embodiment 1 of the present invention.

[FIG. 18] FIG. 18 is a view illustrating a page move process according to embodiment 1 of the present invention.

[FIG. 19] FIG. 19 is a view illustrating a performance management process according to embodiment 2 of the present invention.

[FIG. 20] FIG. 20 is a view illustrating a page move process according to embodiment 2 of the present invention.

### DESCRIPTION OF EMBODIMENTS

Now, the preferred embodiments of the present invention will be described in detail mainly with reference to embodiment 1, and embodiment 2 will be described thereafter.

### Embodiment 1

At first, the outline of the preferred embodiment for carrying out the present invention will be described. The present embodiment 1 is carried out for managing cache tiers of a computer and a storage in conjunction with an application in a computer (in the example of embodiment 1, a virtual computer). Especially in a desktop virtualization environment in which the computer in which a client OS is operated is virtualized, a large number of virtual computers tend to operate in the computer since the CPU load during use is low compared to a server virtualization environment in which a computer having a server OS operated therein is virtualized. However, in the desktop virtualization environment, many users start the virtual computer at a business start time of companies, a so-called boot storm occurs where concentrated I/O occurs to the storage system, causing a drawback that the start time of the virtual computers is delayed.

In order to solve these problems, a copy of the data having a high reference frequency out of the start images is stored in the computer by a managing software of the virtual computer, so that the I/O concentration to the storage system at the time of startup can be prevented and the speed of startup of the VM can be increased. The data copied to the computer or an upper tier within the storage system is data having a high reference frequency. Therefore, the data written in after startup of the VM is not subjected to tier management on the application side, so that there is a drawback that after startup of the VM when a large amount of write requests occur, I/O concentration occurs to the storage area of the storage system, and the performance is deteriorated thereby.

FIG. 1 illustrates a system configuration according to the preferred embodiment for carrying out the present invention. In FIG. 1, a computer 1000 is a computer for performing input and output with respect to a storage system 1400, and includes an FC I/F 1001 for transmitting and receiving input and output data to/from the storage system 1400, an IP I/F 1005 for transmitting and receiving management data with a management computer 1100, a CPU 1002 for executing programs and controlling the whole computer, a memory 1007 which is a storage area for programs, a storage device (HDD) 1006 for storing programs and user data, an input device 1003 such as a keyboard and a mouse used by users for entering information, and an output device 1004 such as a display for displaying information for users.

A management computer 1100 is a computer for managing the computer 1000 and the storage system 1400, and includes an FC I/F 1101 for transmitting and receiving input-output data and control data to/from the storage system 1400, an IP I/F 1105 for transmitting and receiving management data to/from the computer 1000 and the storage system 1400, a CPU 1102 for executing a program and controlling the whole computer, a memory 1107 which is a storage area for storing programs, a storage device (HDD) 1106 for storing programs and user data, an input device such as a keyboard or a mouse through which users can enter information, and an output device 1104 such as a display for displaying data to the users.

An FC switch 1200 is a switch device for transferring input-output data from the computer 1000 to the storage system 1400 and the like, and includes an FC I/F 1203 for transmitting and receiving input-output data, an IP I/F 1204 for transmitting and receiving management data, a CPU 1201 for executing programs and controlling the whole FC switch, and a memory 1202 which is a storage area for storing programs and data.

An IP switch 1300 is a switch device for transferring management data from the management computer 1100 to the computer 1000 and the like, and includes an IP I/F 1303 for transmitting and receiving management data, a CPU 1301 for executing programs and controlling the whole IP switch, and a memory 1302 which is a storage area for storing programs and data.

The storage system 1400 is a node for processing the input-output data from the computer 1000, and includes an FC IF 1401 for receiving the input-output data transferred from the FC switch, an IP I/F 1402 for receiving management data from the management computer 1100, a controller 1403 for executing programs and controlling the whole storage system, a memory 1404 which is a storage area for programs, semiconductor drives (SSDs) 1405 and 1406 and hard disk drives (HDDs) 1407 and 1408 storing user data, pools 1411 and 1412 which are storage areas for user data, an LU 1421 which is a storage area for user data, and pages 1431, 1432, 1433 and 1434 which are data within the LU.

FIG. 2 illustrates a memory configuration of the computer 1000. At the time of startup, the computer 1000 reads into the memory 1007 a data input-output program 2001 for entering and outputting data to the storage system 1400, a computer information management program 2002 for managing the configuration information of the computer, a virtual computer management program (hypervisor) 2003 for operating a virtual computer in the computer, a virtual computer configuration information table 2004 which is a configuration information of the virtual computer, a memory status management table 2005 for showing data of a virtual disk image copied to the memory of the computer, a disk relationship information table 2006 showing the relationship between a virtual disk and a summary file of the virtual disk, a virtual disk information table 2007 showing the contents of the virtual disk, a virtual disk summary information table 2008 showing a hash value of the contents of the virtual disk and whether the disk content has been rewritten or not, and a cache generation date and time management table 2009 for designating the timing for copying the virtual disk summary file and partial data of the virtual disk to the memory.

FIG. 3 shows the memory configuration of the management computer 1100. At the time of startup, the management computer 1100 reads into the memory 1107 a tier management program 3001 for managing the data storage location divided into tiers in the computer 1000 and the storage system 1400, and an application performance information table 3002 having gathered information on the performance of each application based on the configuration information of the computer 1000 and the performance information of the storage system 1400.

FIG. 4 illustrates a memory configuration of the storage system 1400. At the time of startup, the storage system 1400 reads into the memory 1404 a data processing program 4001 for accessing the storage system 1400 from the computer 1000 or the like, a storage information management program 4002 for managing the configuration information and the performance information of the storage system, a storage configuration information table 4003 showing the configuration information of the storage system, a storage tier configuration information table 4004 showing the tier information in multiple disks in the storage system, and a storage performance information table 4005 showing the performance information of the storage system.

FIG. 5 shows the configuration of the virtual computer configuration information table 2004. The virtual computer configuration information table 2004 includes a VM 5001 showing an identifier of virtual computers, an LU 5002 showing an identifier of the LU used by the virtual computer, and a VDisk 5003 showing an identifier of the virtual disk used by the virtual computer.

FIG. 6 shows the configuration of the memory status management table 2005. The memory status management table 2005 includes a memory 6001 showing the data copy destination of the virtual disk, a VDisk 6002 showing an identifier of virtual disks being the data copy source, and a VDisk_LBA 6003 showing a logical block address showing the data storage location of the virtual disks.

FIG. 7 shows the configuration of the disk relationship information table 2006. The disk relationship information table 2006 includes a VM 7001 showing an identifier of the virtual computer using the virtual disk, a VDisk 7002 showing an identifier of the virtual disk used by the virtual computer, and a Digest 7003 showing an identifier of the summary file of the virtual disk.

FIG. 8 shows the configuration of the virtual disk information table 2007. The virtual disk information table 2007 includes an LU 8001 which is an identifier of the LU storing the virtual disk, an LBA 8002 which is a logical block address of the LU, a VDisk 8003 which is an identifier of the virtual disk, a VDisk_LBA 8004 which is a logical block address of the virtual disk, and a Digest 8005 which is an identifier of the summary file.

FIG. 9 shows the configuration of the virtual disk summary information table 2008. The virtual disk summary information table 2008 includes an LU 9001 showing an identifier of the LU storing the summary file, a Digest 9002 showing an identifier of the summary file, a VDisk 9003 showing an identifier of the virtual disk being the target of summarization, a VDisk_LBA 9004 showing a logical block address of the summarized virtual disk, a hash 9005 storing the hash value of the summarized data, and a dirty 9006 which is a flag showing whether or not the target data has been rewritten by the virtual computer after creation of the summary file.

FIG. 10 shows the configuration of the cache generation date and time management table 2009. The cache generation date and time management table 2009 includes a VM 10001 showing an identifier of the virtual computer generating cache, a day 10002 showing the days of the week being the target of generating cache, and a time 10003 showing the time for generating cache.

FIG. 11 shows the configuration of the application performance information table 3002. The application performance information table 3002 includes a VM 11001 showing an identifier of the virtual computer, a page 11002 showing the page constituting the virtual computer, an R_IOPS 10003 showing a read IOPS to each page of the virtual computer, a W_IOPS 11004 showing a write IOPS to each page of the virtual computer, and a threshold 11005 for each virtual VM.

FIG. 12 shows the configuration of the storage configuration information table 4003. The storage configuration information table 4003 includes a storage 12001 showing an identifier of the storage system, an LU 12002 showing an identifier of the LU, and a size 12003 showing the capacity of the LU.

FIG. 13 shows a configuration of the storage tier information table 4004. The storage tier information table 4004 includes a storage 13001 showing the identifier of the storage system, an LU 13002 showing the identifier of the LU, an LBA 13003 which is the logical block address of the LU, a pool 13004 which is an identifier of the pool storing the LU, a page 13005 which is the page constituting the LU, a tier 13006 showing an identifier of the tier storing the page, and a disk 13007 showing the type of the disk constituting the page.

FIG. 14 shows the configuration of the storage performance information table 4005. The storage performance information table 4005 includes a time 14001 showing the date and time of acquisition of performance information, a storage 14002 showing the identifier of the storage system, an LU 14003 showing the identifier of the LU, an LBA 14004 showing the logical block address of the target destination of the issued IO, an R_IOPS 14005 showing the result of totalizing the read IOPS, and a W_IOPS 14006 showing the result of totalizing the write IOPS.

FIG. 15 illustrates a logical configuration including the virtual computers and the virtual disks according to the physical configuration of the computer and the storage system. In the computer 1000, a plurality of virtual computers (VMs) 1010, 1020 and 1030 are operating. Each virtual computer (VM) has a virtual storage area, and the storage area is called a virtual disk. The virtual disk drives are managed as files in the file system of the computer, and the computer stores a file 1012 of virtual disks in a file system of the LU 1420 mounted thereto. Further, the computer 1000 includes a virtual computer management program 2003 called a hypervisor for executing the virtual computers, wherein based on the virtual computer management program (hypervisor) 2003 and the structure of the software managing the same, data having a high reference frequency 1432 is copied from the virtual disk into the memory 1007. Actually, out of the data 1432, 1433 and 1434 constituting the virtual disk 1011, only the data 1432 having a high reference frequency is stored in the memory 1007 of the computer 1000.

An LU 1421 capable of being mounted to the computer exists in the storage system 1400. The LU is composed of pages 1431, 1432, 1433 and 1434, and the respective pages are stored in pools 1411 and 1412 composed of SSDs and HDDs. In the tier management software, the pool composed of SSDs is defined as Tier 1, and the pool composed of HDDs is defined as Tier 2, wherein since Tier 1 is expected to have higher performance than Tier 2, Tier 1 is called an upper tier.

According to the tier management software, cost reduction is realized by storing the data having higher IOPS counted per page to the upper tier, so as to enhance the performance of the storage while reducing the amount of disks of the upper tier, which is generally expensive. In the present example, based on the functions of the tier management software, pages 1431 and 1432 are allocated to the upper tier, and pages 1433 and 1434 are allocated to the lower tier.

FIG. 16 shows a process flow of performance management according to embodiment 1. The tier management program 300 of the management computer 1100 transmits a transmission request of computer related tables to the computer 1000 (step 16001). The computer information management program 2002 of the computer 1000 having received the request transmits the virtual computer configuration information table 2004, the memory status management table 2005, the disk relationship information table 2006, the virtual disk information table 2007, the virtual disk summary information table 2008 and the cache generation date and time management table 2009 to the management computer 1100 (16002).

Next, the tier management program 3001 transmits a transmission request of storage related tables to the storage system 1400 (step 16003). The storage information management program 4002 of the storage system 1400 having received the request transmits the storage configuration information table 4003, the storage tier information table 4004 and the storage performance information table 4005 to the management computer 1100 (step 16004). The timing for transmitting and receiving the respective tables stored in the computer and the storage system can be any timing such as periodically, at a timing when each table has been changed, or prior to executing a cache tier control process.

Thereafter, the computer 1000 executes a process for creating an application cache at a timing of the day of the week and time designated in the cache generation date and time management table 2009 (FIG. 10) (step 16005). The virtual computer management program 2003 of the computer 1000 copies only the data read at high frequencies at the time of startup of the virtual computer to the memory 1007 of the computer 1000. Multiple virtual computers are operated in the computer 1000, and when the virtual computers are used as a desktop, it is assumed that the same OS is installed thereto. Each virtual computer uses the same OS, so that high-speed startup can be realized by the respective virtual computers reading the data necessary at the time of startup from the memory 1007 of the computer 1000.

Next, the tier management program 3001 of the management computer 1100 executes a cache tier control process (step 16007).

The timing for executing the cache tier control process is when the application cache create process is ended or when the application cache create process designated by the cache generation date and time management table 2009 is ended. Regarding the end time of the application cache create process, for example in the case of VM 1010, the time “23:00-08:00” stored in the time 10003 of the cache generation date and time management table 2009 is the process executable time, so that the end timing is “08:00” of the next day next after process execution was started.

FIG. 17 shows a process flow of the cache tier control process 16007 (FIG. 16). The tier management program 3001 of the management computer 1100 reads the virtual computer configuration information table 2004, the memory status management table 2005, the disk relationship information table 2006, the virtual disk information table 2007, the virtual disk summary information table 2008, and the cache generation date and time management table 2009 of the computer 1000, and the application performance information table 3002 of the management computer 1100, and the storage configuration information table 4003, the storage tier information table 4004, and the storage performance information table 4005 of the storage system 1400 (step 17001).

Next, the tier management program 3001 determines a target VM of the cache tier control process from the cache generation date and time management table 2009 (step 17002). The method for determining the target VM of the cache tier control process varies according to the execution timing of the cache tier control process. For example, if the cache tier control process is to be executed at the end time of the application cache create process, at the end time of the application cache create process, the computer 1000 can notify the end timing of the application cache create process to the management computer 1100, and also notify the target VM of the cache tier control process at the same time. Further, if the cache tier control process is to be executed at the end of the application cache create process, the VM having been executing the application cache create process until then is set as the target.

Next, the Digest (virtual disk summary information table 2008) and the VDisk (virtual disk information table 2007) of the target VM is acquired (step 17003), and the page move process is executed (step 17004).

FIG. 18 illustrates a process flow of the page move process 17004 (FIG. 17). The tier management program 3001 of the management computer 1100 reads the application performance information table 3002 (step 18001), and determines whether no data is stored in the memory 1007 of the computer 1000 in the respective VMs (step 18002). This is because data already stored in the memory has small necessity to be newly allocated to the upper tier. If the result of determination is true (Y), that is, if data is not stored, the procedure advances to the next step. If the result of determination is not true (N), that is, if data is already stored, whether the data is a final record or not is determined (step 18005), and if the result of determination is true (Y), in other words, if the data is a final record, the process is ended.

Next, when the above-mentioned result of determination is true (Y), that is, if data is not stored in the memory 1007 of the computer 1000, determination is made on whether the write TOPS (W_IOPS 11004) of the target VM in the application performance information table 3002 has exceeded a threshold (threshold 11005) or not (step 18003), and if the result of determination is true (Y), that is, if the value has exceeded the threshold, the target page is stored in the upper tier (step 18004). In the example, the data is copied to the uppermost tier, but it is also possible to set in advance the tier to which the data is to be copied. The target of the present step is the data not copied by the application cache create process (step 16005). These data are not copied to the cache by the application, but writing of data is assumed to occur after the virtual computer is started. In the present embodiment, the access performance can be improved by storing the pages out of the related pages where write IO exceeding the threshold is occurring to the upper tier. If the result of determination is not true (N), that is, if the value has not reached the threshold, whether the data is a final record or not is determined (step 18005), and if the result of determination is true (Y), that is, if the data is a final record, the process is ended. In the present example, the threshold determination is performed in step 18003, but if there is sufficient storage area, the present determination is not indispensible.

Whether the page in the storage system used by each VM in step 18002 is not stored in the memory 1007 of the computer 1000 or not is determined by the following method. For example, in order to process the virtual computer 1010, records are searched in the virtual computer configuration information table 2004 having the value “1010” stored in VM 5001, based on which a value “1011” of VDisk 5003 is acquired.

Next, records are searched in the disk related information table 2007 having the value “1011” stored in VDisk 8003 and values “1” to “30” stored in VDisk_LBA 8004, based on which the value “1421” of LU 8001 and values “21” to “50” of LBA 8002 of the records are acquired.

Thereafter, records are searched in the memory status management table 2005 having the value “1011” stored in VDisk 6002, based on which values “1” to “10” of VDisk_LBA 2005 are acquired as the virtual disk addresses having these records stored in the memory 1007.

By the steps described above, it can be recognized that out of all the VDisks “1011” used by the virtual computer 1010, the VDisks stored in the memory 1007 are VDisk_LBA “1” to “10”, and the VDisks not stored in the memory 1007 are VDisk_LBA “11” to “30”, so that it can be determined that the former LBAs of LU “1421” are “21” to “30”, and that the latter LBAs thereof are “31” to “50”.

Next, records are searched in the storage tier information table 4004 having the value “1421” stored in LU 13002 and values “21” to “50” stored in LBA 13003, based on which the value “1411” of pool 1304, value “1432” of page 13005 and value “1” of tier 13006, the value “1412” of pool 1304, value “1433” of page 13005 and value “2” of tier 13006, and the value “1412” of pool 1304, value “1434” of page 13005 and value “2” of tier 13006 of these records are acquired sequentially.

Based on these steps, it becomes possible to determine that in the VDisk “1011” used by the virtual computer 1010, the page stored in the memory 1007 is page “1432” of pool “1411”, and that the pages not stored in the memory 1007 are page “1433” of pool “1412” and page “1434” of pool “1412”.

Whether the threshold is exceeded or not in each of the pages of the storage system used by the respective VMs in subsequent step 18003 is determined via the following method. For example, if the pages in the storage system are page “1433” of pool “1412” and page “1434” of pool “1412”, records are searched in the storage tier information table 4004 having the value “1412” stored in pool 13004 and the value “1433” stored in page 13005, and having the value “1412” stored in pool 13004 and the value “1434” stored in page 13005, based on which the value “1421” of LU 13002 and values “31” to “50” of LBA 14003 of these records are acquired.

Next, records are searched in the storage performance information table 4005 having the value “1421” stored in LU 14003 and the values “31” to “50” stored in LBA 14004, based on which the values of R_IOPS 14005 and the values of W_IOPS 14006 of these records are acquired.

At first, in order to compute the read IOPS and the write TOPS of page “1433”, ten records are searched in the storage performance information table 4005 having the value “1421” stored in LU 14003 and the values “31” to “40” stored in LBA 14004, based on which a total value “500” (=50×10) of the R_IOPS 14005 and a total value “500” (=50×10) of the W_IOPS 14006 of these records are acquired.

Next, in order to computer the read IOPS and the write IOPS of page “1434”, ten records are searched in the storage performance information table 4005 having the value “1421” stored in LU 14003 and the values “41” to “50” stored in the LBA 14004, based on which a total value “100” (=10×10) of the R_IOPS 14005 and a total value “1000” (=100×10) of the W_IOPS 14006 of these records are acquired.

The values acquired through these steps are stored in the application performance information table 3002. Then, for example, in order to determine whether the write TOPS has exceeded a threshold or not, the total value “500” of the R_IOPS 1003 which is the write IOPS of page “1433” and the threshold (threshold 11005) are to be compared.

According to the case shown in FIG. 15, the total value of the W_IOPS which is the write IOPS of page 1433 is “500”, and the total value of the W_IOPS which is the write IOPS of page 1434 is “1000”. In that case, since the threshold (threshold 11005) is “800” as shown in the application performance information table 3002, it is determined that the write IOPS to the page 1434 has exceeded a given threshold (refer to a graph display screen 15001 shown in the output device 1104 on the upper left corner of FIG. 15), so that the page 1434 is moved from Tier 2 to upper Tier 1, and stored therein.

According to the present embodiment 1, by managing the tiers of the cache of the storage system and the computer in conjunction with the applications stored in the computer 1000 (virtual computer according to present embodiment 1), it becomes possible to fix the data required for the operation of the application to the upper tier. Thereby, the cost performance regarding the application can be improved.

### Embodiment 2

The outline of embodiment 2 illustrating another example for carrying out the present invention is shown. Embodiment 2 according to the present invention is executed for managing the tiers of the cache of the storage system and the computer assuming the operations of applications in the computer 1000 (virtual computer according to present embodiment 2).

FIG. 19 shows a process flow of performance management according to embodiment 2. The transmission request of a computer related table from the tier management program 3001 of the management computer 1100 to the computer 1000 (step 19001) and the returning of response thereto by the computer information management program 2002 of the computer 1000 (step 19002), and similarly, the transmission request of a storage related table of the tier management program 3001 to the storage system 1400 (step 19003) and the returning of response thereto by the storage information management program 4002 of the storage system 1400 (step 19004) are the same as embodiment 1, so the detailed description thereof are omitted.

According to the present embodiment 2, the tier management program 3001 of the management computer 1100 executes the cache tier control process without executing an application cache create process by the computer 1000 performed in embodiment 1 (step 19005). The timing of executing the cache tier control process is the timing when the computer 1000 issues an IO to the summary file 1012. When an IO is issued from the VM to the virtual disk 1011, the computer 1000 accesses the summary file 1012, and after confirming that the corresponding section has been rewritten, issues an IO to the virtual disk 1011. Therefore, it becomes possible to determine the LBA of the summary file 1012 by referring to the virtual disk information table 2007 acquired by the management computer 1100, and further, it becomes possible to determine the pools and pages of the summary file 1012 by referring to the storage tier information table 4004. Thus, it becomes possible to determine whether an IO has been issued to the summary file 1012 or not.

FIG. 20 shows a process flow of the page move process executed during the cache tier control process. The tier management program 3001 of the management computer 1100 reads in the application performance information table 3002 (step 20001), determines whether the write IOPS of the target VM (W_IOPS 11004) has exceeded a threshold (threshold 11005) or not (step 20002), and if the result of determination is true (Y), that is, if the value has exceeded the threshold, the target page is stored in the upper tier (step 20003). Thereafter, whether the record is a final record or not is determined (step 20004), and if the result of determination is true (Y), that is, if the record is a final record, the process is ended.

Based on the present embodiment 2, by physically copying only the difference volume having a high access frequency to the upper tier during load distribution, it becomes possible to reduce the amount of use of the disks while maintaining performance.

The above described embodiment discloses an example of executing tier management of the related page of data stored in the cache in conjunction with the operation of storing the data having a high reference frequency in the cache of the computer out of the start images by the management software of the virtual computer. However, the present invention is not restricted to this embodiment. The present invention only requires to process accesses to a specific data and to execute tier control in conjunction with other data in a state where application related data is subjected to management.

For example, there is a form of use called a virtualized application, wherein an application image having all the necessary data such as library files for operation in multiple operating systems is formed into a package, and every time the application is started or used, the package is read in from the storage system. In a virtualized application, in order to realize high-speed startup of the application, only the application image required for startup is read in from the storage system, and the application image required after startup of the application is designed to be read in the background during operation of the application.

The application image stored in the storage system is possibly tiered via a tier management software and the like, and there is a drawback that the operation of the application becomes slow if the image is stored in a lower tier. Therefore, the relationship between the VDisk and the Digest described in FIG. 7 of embodiment 1 classified into “application image required after startup” and “application image required for startup”, so that when IO occurs to the “application image required for startup”, the related “application image required after startup” will be stored in the upper tier. According to the configuration of the present embodiment, the speed of operation of applications can be increased.

If the application is a database, multiple data are stored in the storage system, such as a table area where user data and the like are stored in the database, and a log area used for restoring data during logical failure and the like. The relationship between the VDisk and the Digest described in FIG. 7 is configured as a “log area” and a “table area” according to the present embodiment. Thereby, when IO occurs to the “table area”, a “log area” for enabling write complete of the table area is set to be stored in the upper tier. According to the present arrangement, the log data that had been mostly allocated in the lower tier compared to the table area according to normal tier control of the prior art can be stored in advance in the upper tier, so that the speed of operation of the application can be enhanced.

### REFERENCE SIGNS LIST

1000 Computer
1100 Management computer
1200 FC switch
1300 IP switch
1400 Storage system

1-3. (canceled)

4. A storage tier management system comprising:
a computer operating one or more virtual computers therein;
a management computer; and
a storage system including multiple types of storage devices;
wherein the management computer
performs tier management of data in a unit of pages with respect to data storage location divided into tiers by the memory and the multiple types of storage devices;
manages access frequency for each page; and
manages a timing of executing a tier control for each virtual computer, and at the timing
the computer copies, based on the managed access frequency, data read at high frequencies out of data used by the virtual computers stored in the multiple types of storage devices to own memory, and
the management computer migrates the page to an upper tier, when the managed access frequency of the data out of data used by the virtual computer stored in the multiple types of storage devices, other than the data already stored in the memory, exceeds a predetermined threshold.

5. The storage tier management system according to claim 4, comprising
a table which manages a relationship between the virtual computer, a storage area used by the virtual computer, the memory, and each storage location of the multiple types of storage devices, and
wherein the management computer executes migration to the upper tier based on the table.

6. A storage tier management system comprising:
a computer operating one or more virtual computers therein;
a management computer; and
a storage system including multiple types of storage devices;
wherein the management computer
performs tier management of data in a unit of pages with respect to data storage location divided into tiers by the multiple types of storage devices; and
taking a timing when the computer requests access to specific file as a trigger, when an access frequency to the page constituting the virtual computer shown by the accessed specific file exceeds a predetermined threshold, migrates the page to an upper tier.

7. A storage tier management system comprising:
a computer operating a database as an application;
a management computer; and
a storage system including multiple types of storage devices;
the multiple types of storage devices having a table area for storing user data and the like to the database and a log area for storing log data for restoring from failure;
wherein the management computer
performs tier management of data among the multiple types of storage devices; and
when access occurs to the table area via a processing of an application, migrates the log area to an upper tier.

8. (canceled)
